(19) United States
(12) Patent Application Publication
(10) Pub. No.: US 2004/0241473 A1
(43) Pub. Date: Dec. 2, 2004

(54) Method of processing a used hdpe by means of extrusion-blow moulding

(76) Inventors: Eric Fassiau, Bruxelles (BE); Jean-Christophe Lepers, Walhain (BE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/489,687

(22) PCT Filed: Sep. 13, 2002
(86) PCT No.: PCT/EP02/10389

(30) Foreign Application Priority Data
Sep. 14, 2001 (FR) 01/12016

(51) Int. Cl. B32B 27/00

(52) U.S. Cl. 428/500; 220/4.14

(57) ABSTRACT

Process for the processing of a waste high density polyethylene (HDPE) in particulate form by extrusion-blow moulding, according to which the waste HDPE is extruded as a blend with a polyfunctional epoxide and the extrudate is subsequently subjected to a blow moulding operation.

The present invention relates to a process for processing an HDPE High density polyethylene) by extrusion-blow moulding and to fuel tanks capable of being obtained using this process.

The increasing use of plastics has presented an environmental problem for many years. Thus, for example, in the automobile industry, legislation has been planned in order to impose a minimum degree of recycling by weight of the plastics used. A fuel tank, which is often produced by extrusion-blow moulding of high density polyethylene (HDPE), is an advantageous candidate as, its weight being high, it provides, by itself alone, a significant function of the degree by weight to be recycled. However, to date, no project has succeeded in blow moulding tanks including even only a portion of recycled resin. This is because the extrusion-blow moulding technique is only applicable to resins which have good melt behaviour and which are highly homogeneous, which is not usually the case with recycled resins following decomposition undergone by the resin during its lifetime and/or its reprocessing.

Generally, the resins and in particular HDPE are stabilized so as to limit the decomposition during their lifetime as solid object but this stabilization is not, however, sufficient during the reprocessing of waste resins. It is consequently known to add, to these resins, during their reprocessing, one or more stabilizers in order to make possible this reprocessing and subsequent use without damage. This, in the case of HDPE, it is known that the extrusion results in high decomposition of the polymer chains and that it is advisable to restabilize the waste polymer before reprocessing it (Kartalis et al., Journal of Applied Polymer Science, Vol. 73, 1775-1785 (1999)). However, such a restabilization generally does not make it possible to obtain, at the outlet of the extruder, a product suitable for processing by blow moulding. This is because the majority of the recycled resins, even restabilized resins, exhibit, in the molten state, a totally unacceptable elongation under their own weight which makes it impossible to handle the parisons during the blow moulding.

Application EP 1 095 978 discloses the extrusion of compositions comprising HDPE, at least one polyfunctional polymer or oligomer having a glass transition temperature of less than 10° C. (polysiloxane) and a polyfunctional epoxide under conditions involving a reduction in the melt index (MI).However, the specific use of such resins for extrusion-blow moulding, in particular of petrol tanks, is not disclosed.

It has transpired, surprisingly, that the processing by extrusion-blow moulding of a waste HDPE is possible provided that it is modified by extrusion as a blend with a polyfunctional epoxide. In addition, the resin thus modified exhibits improved mechanical properties in comparison with the virgin base resin and an improved ability to be rendered impermeable by fluorination.

The present invention consequently relates to a process for the processing by extrusion-blow moulding of a waste high density polyethylene (HDPE) in particulate form, according to which the waste HDPE is extruded as a blend with a polyfunctional epoxide and the extrudate is subsequently subjected to a blow moulding operation.

The HDPE which can be processed by the process according to the present invention can be a homopolymer of ethylene or a copolymer of ethylene with a monomer such as propylene, butene, hexene or octene, in a content generally of greater than 20%, indeed even of 4%, and generally not exceeding 10%, indeed even 8%. It is preferably a copolymer of ethylene and of hexene having a hexene content of between 4 and 8%. This resin can, for example, be obtained by using a Phillips catalyst or a Ziegler catalyst. Resins of the Phillips type are preferred. The density of this resin is generally greater than or equal to 930, preferably greater than or equal to 940, indeed even greater than or equal to 945, g/kg. The resins exhibiting an MI (measured at 190° C. according to Standard ISO 1133) of less than or equal to 1 g/10 min under a load of 5 kg and of greater than or equal to 1 under a load of 21.6 kg give good results.

The term “waste resin” according to the present invention is intended to denote a resin which has already been subjected to at least one melt forming (other than a simple granulation) and which has had a not insignificant lifetime in this form, during which it has been subjected to not insignificant decomposition (and in particular oxidation) phenomena. The present invention is particularly welt suited to “aged” resins which have been polymerized and processed months, indeed even years, before (20 to 25, for example) and which have even been used in an aggressive chemical and/or thermal environment, such as the constituent resins of waste fuel tanks.

According to the present invention, the HDPE is in the particulate form, that is to say in the form of particles (powder, granules, fragments, and the like) so as to be able to be effectively introduced into the extruder and melted.

According to the present invention, during the blow moulding, the extrudate can be used as is or as a blend with waste but non-additivated resin (that is to say, which has not been extruded as a blend with a polyfunctional epoxide) and/or with ““virgin” resin. The term ““virgin” resin” according to the present invention is intended to denote a resin which has not been subjected to any melt forming (with the exception of a possible granulation) and which has not been subjected to significant decomposition. According to the present invention, the extrudate is advantageously used as a blend with non-additivated waste resin or virgin resin in proportions by weight of 60:40 to 40:60. Waste HDPEs of various origins can also be used as a blend and can optionally also be diluted with virgin resin, in the same proportions as those described above.

The polyfunctional epoxide according to the present invention is preferably of the same type as those disclosed in Patent Applications WO 94/29377, WO 97/30112, WO 00/26286 and EP 1 095 978. This epoxide is preferably combined with a hindered phenol and with a phosphite (as disclosed in WO 94/29377), with an aromatic secondary amine (as disclosed in WO 97/30112) or with a polyfunctional polymer or oligomer with a glass transition temperature of less than 10° C. (as disclosed in EP 1 095 978). The choice as epoxide of a compound comprising at least one (preferably two) epoxy functional group(s) and at least one (preferably two) alkenyl group(s) (as disclosed in WO 00/26286) gives good results. The choice of a mixture based on a polyfunctional epoxide combined with a hindered phenol and/or with a phosphite and/or with an acid scavenger gives particularly good results. Such a mixture is sold by Ciba-Geigy under the trade name Recycloblend® 660. In the case of the use of Recycloblend® 660 mixture, the choice will preferably be made of a percentage by weight of the Recycloblend (with respect to the (recycloblend+HDPE) combination) of at least 0.1%, preferably of at least 0.3%, indeed even of at least 0.4%, but not exceeding 1%, preferably 0.7%, indeed even 0.6%. A content by weigh of 0.5% gives good results.

Other additives can also be incorporated in the HDPE during the processing process according to the present invention. Thus, for example, stabilizing agents (such as the abovementioned phenols and phosphites), carbon black, and the like, can be introduced therein, all of them in conventional amounts (typically from 0 to 5 g/kg).

In the present invention, the extrusion as a mixture with the polyfunctional epoxide (or “additivation”) is preferably carried out under high shear stresses which make it possible to obtain a significant reduction in the MI (measured at 190° C. according to Standard ISO 1133 and under a suitable load in order to obtain a value of greater than or equal to 1 g/10 min). The term “significant reduction” in the MI is generally understood to mean a reduction of at least 5%, preferably of at least 10%, indeed even of at least 15%, in the MI with respect to its initial value before extrusion).

According to the present invention, the HDPE can be extruded in a single-screw or twin-screw extruder. Twin-screw extruders are preferred as they bring about a higher degree of shearing, which makes it possible to melt the material more rapidly. The profile of the screw or screws of these extruders will be adjusted in a known way by a person skilled in the art. Thus, for example, mixing elements will be introduced as soon as possible into the screws. Preferably, these mixing elements are introduced from the first third of the screw. It is also possible, in the case of singe-screw extruders, which have a poorer mixing effect, to resort to the use of a grooved barrel.

The polyfunctional epoxide is advantageously preblended with virgin resin in the form of powder (fluff) and is then introduced, with the resin to be stabilized, into the extruder via the main hopper.

The extrusion conditions (rotational speed, temperature profile, and the like) are to be optimized according to the screw profile chosen, taking into account the torque available on the chosen machine. The elder is advantageously provided with a filter which is sufficiently large to effectively filter the stream of molten material without excessively increasing the pressure.

In the process according to the present invention, the forming by extrusion-blow moulding can be carried out in a single stage, that is to say that the molten HDPE exiting from the extruder where it is has been additivated is put directly into the form of a parison and that the latter is then directly blow moulded, in line with the extruder used for the additivation. Alternatively, and preferably, the HDPE is granulated at the outlet of the extruder where it had been additivated and is subsequently subjected to forming by extrusion-blow moulding, optionally as a blend with non-additivated waste resin and/or with virgin resin. The extrusion-blow moulding parameters (screw speed, temperature and the like) used in this case are similar to those used for the virgin resin.

Preferably, the process according to the present invention is intended for the manufacture of hollow bodies intended to contain or to convey fuel. According to this alternative form of the invention, the word “fuel” denotes both petrol and diesel or any other fuel used in internal combustion engines. Preferably, the hollow bodies are fuel tanks or pipes.

The process according to the present invention applies particularly well to HDPEs originating from waste fuel tanks which have already been processed by extrusion-blow moulding. According to this alternative form of the invention, an HDPE originating from a petrol tank can be blended with an HDPE originating from a diesel tank.

Fuel tanks generally comprise metal components (such as the cartridge of the petrol filter, the ball of the nonreturn valve, the rotor of the pump, and the like) which it is important to separate from the HDPE before subjecting the latter to the process according to this alternative form of the invention. In addition, given that the extrusion requires having the resin available in a divided form, the tank is generally milled before its constituent resin is subjected to the process according to this alternative form of the invention.

It is also important to remove, from the HDPE, the hydrocarbon residues which might be found therein before applying to it the process according to this alternative form of the present invention. To this end, it is possible, for example, to use extraction by means of a solvent (for example, n-hexane) or of supercritical CO₂ (to remove the heavy hydrocarbon residues) and/or stripping by means of steam (to remove the light hydrocarbon residues). This operation is preferably carried out on the milled resin and not on the skeleton of the tank.

It is important to note that, when this alternative form of the invention is applied to an industrial process for the manufacture of petrol tanks, these tanks generally comprise different resins, namely: virgin resin, resin resulting from additivated waste tanks, and a blend of such resins having already been processed several times. This is because it is generally advantageous not to blow mould pure recycled resin but recycled resin only in a percentage by weight corresponding to that laid down by environmental standards and/or the profitability of the process. In addition, only approximately 40% of a blow-moulded parison actually constitutes the tank, the remainder being waste, which is also recycled to the blow moulding.

Furthermore, it transpired that, surprisingly, when fluorine is injected into a tank including additivated waste resin according to the present invention, the F/C ratio is substantially the same at the surface and at the core in the tank. Consequently, the present invention also relates to petrol tanks capable of being obtained by the process described above and exhibiting an F/C ratio which is substantially identical at the surface and at the core in the tank. This F/C ratio can, for example, be measured by XPS (X-Ray Photoelectron Spectroscopy). In this case, a measurement normal to the surface (referred to as 0° measurement) gives the F/C ratio at the core and an oblique measurement (or 60° measurement) gives the F/C ratio at the surface.

The present invention is illustrated without implied limitation by the following example:

### EXAMPLE

A blend of virgin and recycled resins similar to that which would be extruded-blow moulded in an industrial process was manufactured using, as primary source (“fresh” product), 70% of virgin resin and 30% of resin resulting from waste and additivated tanks, with the degree of recycling related to the processing of 60% (i.e., the use of 40% of “fresh” product and of 60% of “remilled” product), by a multistage process:

1—Treatment of the Tanks:

Waste fuel tanks were subjected to the following stages:

shredding under a water atmosphere to prevent explosions,

removal of metals where ferromagnetic metals are removed by a permanent magnet; nonferromagnetic metals are removed by a system with an induced magnetic field,

milling and draining to remove dust,

separation by a settling bath,

washing with hot hexane to remove the heavy hydrocarbons,

stripping to remove the light hydrocarbons.

2—Additivation:

The resin obtained in stage 1 is extruded with 0.5% of Recycloblend° 660 in a corotating twin-screw extruder (BC 45) rotating at 111 rpm, using the following screw profile and following temperature profile.

| | | | | | Set |
|---|---|---|---|---|---|
| No. of | Cumulative | | | | tempera- |
| the com- | length | Code of the | Pitch | Length | ture |
| ponent | (mm) | component | (mm) | (mm) | (° C.) |
| Z1 | 100 | A: 50/100 | 50.0 | 100 | 180 |
| | 200 | A:50/100 | 50.0 | 100 | |
| Z2 | 300 | B:33/100 | 33.3 | 100 | 190 |
| | 400 | B:33/100 | 33.3 | 100 | |
| Z3 | 500 | C:25/100 | 25.0 | 100 | 210 |
| | 600 | E:14/100 | 14.3 | 100 | |
| Z4 | 675 | 6I/KB | 0.0 | 75 | 210 |
| | | 90/6/75 | | | |
| | 700 | G:−50/25 | −50.0 | 25 | |
| | 800 | C:25/100 | 25.0 | 100 | |
| Z5 | 900 | C:25/100 | 25.0 | 100 | 200 |
| | 1000 | C:25/100 | 25.0 | 100 | |
| Z6 | 1100 | C:25/100 | 25.0 | 100 | 200 |
| | 1200 | C:25/100 | 25.0 | 100 | |
| Z7 | 1300 | D:25/100 | 16.7 | 100 | 200 |
| | 1400 | D:25/100 | 16.7 | 100 | |
| Filter | | | | | 185 |
| Die | | | | | 200 |

The MI (190° C. 21.6 kg of the resin was 6.4 g/10 min before this extrusion and 5.6 g/10 min. after, i.e. a reduction of 13%.

3—Preparation of the Fresh Product:

70% of virgin resin (Eltex RSB 174) were blended with 30% of recycled resin obtained in stage 2.

4—Preparation of the Remilled Product:

The fresh product prepared in stage 3 was blow moulded under standard conditions on an extrusion blow-moulding device of BAT 1000 type. The tanks are produced by continuous extrusion under the following conditions: head: BKC 400; die 500 mm; mould: X74. These tanks were remilled and re(blow moulded) 3 times.

5—Manufacture of the Tanks for Evaluation:

40% of the fresh product (stage 3) was blended with 60% of the remilled product (stage 4). The blend was blow moulded under the same conditions as those of stage 4. At the end of the blow moulding, fluorine was injected into the tank.

Eltex RSB 714, to which antioxidant N0060 had been added, was also extruded and blow moulded as in stage 4.

Finally, a recycled product which has been subjected to stages 1, 2 and 3 but which has not been readditivated with Recycloblend® 660 in stage 2 but with 0.2% of a conventional antioxidant (Irganox® B225) was also extruded and blow moulded as in stage 4.

6—Evaluation of the Results:

XPS Measurements

In order to determine the effect of the fluorination on the internal surface of the tanks, an XPS (X-Ray Photoelectron Spectroscopy) study was carried out. An XSAM800 (Kratos) X-ray spectrometer was used in “Fixed Analyser Transmission” mode with a pass energy of 10 eV and non-monochromatized MgK_{α} X-rays (hv=1253.7 eV). The operating parameters were 13 kV and 10 mA. Analyses were carried out in a chamber kept under ultrahigh vacuum (UHV) of 10⁻⁷ PA. The results were analyzed via an algorithm using least squares in a mixed Gaussian/Lorentzian mode.

The F/C atomic ratio was measured on the 3 samples. A measurement was taken perpendicularly to the surface (normal: 0°) and obliquely with respect to the surface (angle of 60°). The normal measurement (0°) gives an idea of the bulk concentration; the 60° measurement is an indication of the surface concentration. The higher the F/C ratio, the more fluorine there is bonded chemically to the carbon: a ratio of 2 indicates that —CF₂— groups are present.

| | | Recycled virgin + | Recycled virgin + |
|---|---|---|---|
| Angle of the | 100% Virgin | Recyclo- | standard |
| measurement | resin | blend ® 660 | antioxidant |
| 0° (Bulk) | 1.77 | 1.86 | 1.70 |
| 60° (Surface) | 1.88 | 1.865 | 1.75 |

As regards the concentration of fluorine (bulk), the sample recycled with Recycloblend® 660 has the highest concentration of fluorine. Furthermore, this concentration appears to be constant as a function of the thickness. The fluorine layer appears to be the most continuous. As regards the concentration of fluorine in the virgin resin, this appears to be lower overall but slightly higher at the surface. There is therefore slightly more fluorine at the surface but this content rapidly decreases with depth (shallower layer). As regards the recycled resin comprising only antioxidant, this has a lower concentration both at the surface and at depth.

Measurement of the Properties of the Tanks

Various tests have been carried out on the tanks. In the burst test, the pressure inside the tank is steadily increased until the tank bursts. In the drop test, a tank filled with cold ethylene glycol (−40° C.) is released from an increasingly great height until the tank bursts. For the permeability, the loss in weight observed during 24 hours of a diurnal/nocturnal temperature cycle (after 24 weeks).

| | 100% | Recycled virgin + | |
|---|---|---|---|
| | Virgin | Recyclo- | Recycled virgin + |
| Property | resin | blend ® 660 | antioxidant |
| Bursting pressure | 2.6 | 2.6 | 3.1 |
| (bar) | | | |
| Drop height (m) | 5 | 6 | 5 |
| Permeability | 0.19 | 0.13 | 0.20 |
| (g/CARB) | | | |

For all the tests, the recycled resin comprising Recycloblend® is better than the virgin resin and is better than the recycled resin comprising the standard antioxidant.

Measurement of the Rheological Properties of the Resins

In order to compare the rheological properties of the resins, the viscosity at 190° and at the shear rate of 1 seo⁻¹ was measured on a 0.3/l die. In this type of die, the flow has essentially an elongational component. The viscosities were measured on the starting resins, after the 3 blow moulding/milling cycles and after blending with the “fresh” resin.

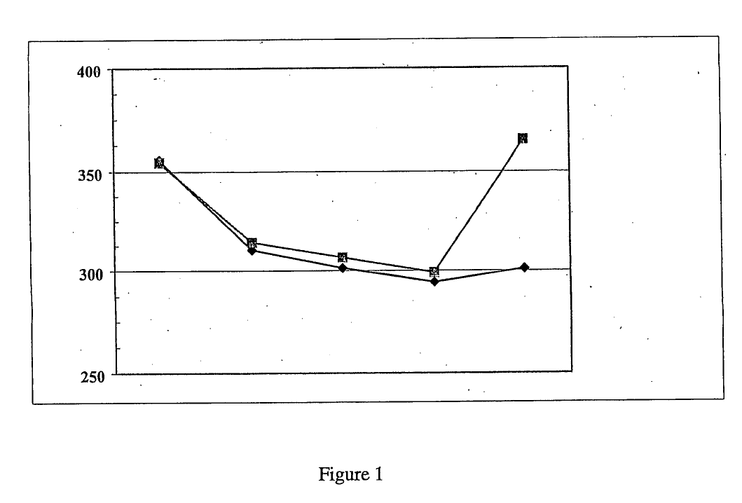

The result of the rheological measurements is represented in FIG. 1, where the upper curve relates to resin additivated with Recycloblend® 660 and where the lower curve relates to the resin additivated with Irganox® B225. The points of these curves relate, in this order, to the “fresh” product, to the “fresh” product processed and remilled once, twice and 3 times, and to the final 40/60 blend (“fresh” product/remilled product). The ordinate of these curves is the viscosity, measured under the conditions described above.

During the blow moulding/milling cycle, it may be observed that the viscosity gradually decreases. When this product is blended with the fresh product additivated with Recycloblend® 660, a recovery in the rheological properties (viscosity) is observed and it is thus possible to repair the oxidation which the product bas been subjected to. This improvement in the behaviour is not observed when the additive used is a simple antioxidant.

1- Process for the processing by extrusion-blow moulding of a waste high density polyethylene (HDPE) in particulate form, according to which the waste HDPE is extruded as a blend with a polyfunctional epoxide and the extrudate is subsequently subjected to a blow moulding operation.

2- Process according to claim 1, in which the extrudate is diluted with non-additivated waste HDPE and/or virgin HDPE.

3- Process according to claim 1 or 2, in which the polyfunctional epoxide is combined with a hindered phenol and/or with a phosphite and/or with an acid scavenger.

4- Process according to any one of the preceding claims, in which the extrusion is carried out under high shear stresses which make it possible to obtain a reduction in the melt index of the HDPE (measured at 190° C. according to Standard ISO 1133 and under a suitable load for obtaining a value of greater than or equal to 1 g/10 min) of at least 5% with respect to its value before extrusion.

5- Process according to any one of the preceding claims, in which the extrusion is carried out in a twin-screw extruder equipped with mixing elements positioned from the first third of the screws.

6- Process according to any one of the preceding claims, for the manufacture of hollow bodies intended to comprise or to convey fuel.

7- Process according to the preceding claim, for the manufacture of fuel tanks and pipes.

8- Process according to any one of the preceding claims in which the waste HDPE originates from waste fuel tanks or pipes.

9- Process according to the preceding claim, in which the we HDPE has been subjected to emotion by means of a solvent or of supercritical CO₂ and/or stripping by means of steam before the extrusion.

10- Fuel tank capable of being obtained by the process according to any one of the preceding claims, characterized in that it exhibits an F/C ratio which is substantially identical at the surface and at the core.
